(19) United States
(12) Patent Application Publication
(10) Pub. No.: US 2013/0065617 A1
(43) Pub. Date: Mar. 14, 2013

(54) System for Reducing Radiation for Cellular Users

(71) Applicant: Gilad PELED, Tel Aviv (IL)

(72) Inventor: Gilad PELED, Tel Aviv (IL)

(73) Assignee: MO-B-SAFE LTD., Tel Aviv (IL)

(21) Appl. No.: 13/231,978

(22) Filed: Sep. 14, 2011

(51) Int. Cl. H04W 4/14; H04W 88/04

(52) U.S. Cl. 455/466; 455/569.1

(57) ABSTRACT

The system, which retrofits existing brand mobile telephones by adding short range audio and command application and by adding a server to distance harmful radiation, comprises a server, a client mobile telephone having a long range and a short range transceiver, the client having a SIM module. The server has a short range and a long range transceiver and a second SIM module that has priority over the client with the network. The server, when in communication range with the client, receives the incoming call from the base station, transfers audio to the client by short range communication, receives audio from the client handset and transmit a signal corresponding to the audio to the base station. In a remote SIM version, instead of server having a physical second subscriber identification module, the client's SIM module data is sent by short range communication from the client to the server

### FIELD AND BACKGROUND OF THE INVENTION

The present invention relates to systems and methods for reducing exposure to cellular radiation, and, more particularly for such systems and methods that are applicable to retrofit existing cellular telephones.

The problem with harmful radiation from use of cellular telephones is well known. Cellular telephones generate energy levels between approximately 1 and approximately 3 Watts during a call. The electric power levels are proportional to the electromagnetic radiation emitted from the cellular phone. The mobile phones are normally placed against the user's head when speaking during a call. Many children, whose skulls are thinner than those of adults, have become accustomed to using cellular telephones and the harmful radiation penetrates significantly further into their brains than equivalent radiation penetrates into adult brains. Although there is scientific disagreement as to the extent of the danger, several significant scientific studies have reported increased risk of brain cancer from use of mobile telephones and that the risk is proportionate to the amount of the use. The danger may also depend on which parts of the body the mobile telephone is placed near. It is generally believed that the source of the radiation should be distanced from the body by about 12 inches. Since radiation is inversely proportional to the square of the distance between the source and the target, distancing the mobile telephone from the body tissue is an important consideration.

Cellular telephone usage has increase exponentially over the last twenty years, particularly among young people, including children. Yet many people believe that the nature of the danger is such that the dreaded results would not necessarily show up until many decades of use has been logged, at which point it would be too late for many people to protect against the harm.

There is a compelling need for a system and method of cellular telephone use that prevents or reduces harmful cellular radiation and to do so now while the effects are being studied. It would be particularly helpful if such a system could be applicable to as many cellular users as possible without compromising either the quality of the service of the comfort of use of the mobile telephone.

### SUMMARY OF THE PRESENT INVENTION

One aspect of the present invention is a system for mobile telephones that reduces haiuiful radiation, comprising a server; a client comprising a stand-alone mobile telephone including a long range transceiver for communication with a cellular base station, a handset and a user interface and including a short range transceiver and an application for short range communication with the server, the client having a first subscriber identification module associated with a telephone number and configured to, using short range communication, (i) send audio derived from a client handset to the server, (ii) receive audio from the server and play the audio received form the server on a speaker and (iii) send commands to and receive commands from the server; the server comprising a processor, a long range transceiver for communication with the cellular base station when the client and server are in communication range and a short range transceiver for communication with the client, the server having a second subscriber identification module, the second subscriber identification module being associated with the telephone number, the server configured in relation to a cellular network to which the cellular base station is connected that the server having the second subscriber identification module has one of (i) call routing in parallel to the client that has the first subscriber identification module, and (ii) call routing priority over the client, the server configured, when in communication range with the client, to receive an incoming call from the cellular base station, to transfer audio from the incoming call to the client by short range communication, to receive audio from a client handset by short range communication and to transmit a signal corresponding to audio derived from the client handset to the cellular base station during the incoming call, the server also configured to send and receive commands to and from the client.

A further aspect of the present invention is a system for mobile telephones that reduces harmful radiation, comprising a server; a client comprising a stand-alone mobile telephone including a long range transceiver for communication with a cellular base station, a handset and user interface and including a short range transceiver and an application for short range communication with a server, the client having a subscriber identification module and configured, when the client is not in short range communication with the server, to be enabled for communication with a cellular network of the cellular base station, the client also configured to, using short range communication, (i) send audio derived from a client handset to the server, (ii) receive audio from the server and play the audio received from the server on a speaker and (iii) send commands to and receive commands from the server; the server comprising a processor, a long range transceiver for communication with the cellular base station when the client and server are in communication range and a short range transceiver for communication with the client, the server not having a subscriber identification module and configured to be disconnected from the cellular network when the server is not in communication with the client; the client and the server configured such that when the client is in communication range with the server, the client transfers subscriber identification module data of the subscriber identification module to the server thereby enabling the server to be recognized for communication by the cellular base station and the client to be disconnected from the cellular network, cellular communication being routed to the server, the server configured to transfer audio from the incoming call to the client by short range communication, to receive audio from the client handset by short range communication and to transmit to the cellular base station a signal corresponding to audio derived from the client handset during the incoming call, the server also configured to send commands to and receive commands from the client.

A still further aspect of the present invention is a method of retrofitting a mobile telephone to reduce harmful radiation, the mobile telephone being a stand-alone mobile telephone having a long range transceiver for communication with a cellular base station, a handset, a user interface, a first subscriber identification module associated with a telephone number and a short range transceiver, the method comprising incorporating an application to the stand-alone mobile telephone to make it a client that is configured to, using short range communication, (i) send audio derived from a client handset to the server, (ii) receive audio from the server and play the audio received from the server on a speaker and (iii) send and receive commands to and from the server; positioning the server within a short range communication distance from a location in which a user intends to use the client, the server having a processor, a long range transceiver for communication with the cellular base station when the client and server are in communication range and a short range transceiver for communication with the client, the server having a second subscriber identification module associated with the telephone number; providing the server having the second subscriber identification module with call routing that is either (i) in parallel to or (ii) with priority over, the stand-alone mobile telephone that has the first subscriber identification module; and configuring the server, when in communication range with the client, to receive an incoming call from the cellular base station, to transfer audio from the incoming call to the client by short range communication, to receive audio from the client handset by short range communication and to transmit a signal corresponding to audio derived from the client handset to the cellular base station during the incoming call, the server also configured to send and receive commands to and from the client.

Another aspect of the present invention is a method of retrofitting a mobile telephone to reduce harmful radiation, the mobile telephone being a stand-alone mobile telephone having a long range transceiver for communication with a cellular base station, a handset, a user interface, a subscriber identification module and a short range transceiver, the method comprising incorporating an application to the stand-alone mobile telephone, to make it a client that is configured to, using short range communication, (i) send audio derived from a client handset to the server, (ii) receive audio from the server and play the audio received from the server on a speaker and (iii) send and receive commands to and from the server; positioning the server within a short range communication distance from a location in which a user intends to use the client, the server having a processor, a long range transceiver for communication with the cellular base station when the client and server are in communication range and a short range transceiver for communication with the client, the server not having a subscriber identification module; configuring the server to be disconnected from the cellular network when the server is not in communication with the client; configuring the client and the server such that when the client is in communication range with the server, the client transfers subscriber identification module data of the subscriber identification module to the server using short range communication, the server is connected to the cellular network and the client is disconnected from the cellular network; and configuring the server to transfer audio from the incoming call to the client by short range communication, to receive audio from the client handset by short range communication and to transmit to the cellular base station a signal to corresponding to audio derived from the client handset during the incoming call, the server also configured to send commands to and receive commands from the client.

These and other features, aspects and advantages of the present invention will become better understood with reference to the following drawings, descriptions and claims.

### BRIEF DESCRIPTION OF THE DRAWINGS

Various embodiments are herein described, by way of example only, with reference to the accompanying drawings, wherein:

FIG. 1 is a schematic illustration of a mobile telephone system showing just the client and the cellular base station since the client is not in short range communication with the server yet, in accordance with one embodiment of the present invention;

FIG. 2 is a schematic illustration of a mobile telephone system including the client and server in short range communication with one another, in accordance with one embodiment of the present invention;

FIG. 3 is a schematic illustration of a mobile telephone system including the client and a server in short range communication with one another, in accordance with one embodiment of the present invention;

FIG. 4 is a flow chart showing a method in accordance with one embodiment of the present invention; and

FIGS. 5A-5B are flow charts showing a further method in accordance with a further embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention generally provides a method and system for retrofitting existing brand mobile telephones to reduce harmful radiation by adding a server device to the client-mobile telephone that already has a long range transceiver. The client mobile telephone may have a short range transceiver and may be given an application for short range communication with the server. The client may have a first subscriber identification module associated with a telephone number and may be configured to not receive incoming calls from the cellular base station when the client is in communication with the server. The client may also be configured to, using short range communication, (i) send audio derived from a client handset to the server, (ii) receive audio from the server and play the audio received form the server on a speaker and (iii) send commands to and receive commands from the server. The server may have a processor, a long range transceiver for communication with the cellular base station when the client and server are in communication range, a short range transceiver for communication with the client, and a second subscriber identification module being associated with the same telephone number as the first subscriber identification module, the cellular network routing calls to the server in parallel to the client or pursuant to call routing priority over the client. The server may be configured, when in communication range with the client, to receive an incoming call from the cellular base station, to transfer audio from the incoming call to the client by short range communication, to receive audio from the client handset by short range communication and to transmit a signal corresponding to audio derived from the client handset to the cellular base station during the incoming call. When the client is not in communication with the server, the server may be disconnected from the cellular network.

In a “remote SIM” version, the server may have no subscriber identification module and may be configured to be disconnected from the cellular network when the server is not in communication with the client. In the remote SIM option, the client and the server may be configured when in short range communication with each other, that the client transfers subscriber identification module data of the subscriber identification module to the server and the cellular base station routes the incoming call to the server and the client may be disconnected from the cellular network, the server may be configured to transfer audio from the incoming call to the client by short range communication, to receive audio from the client handset by short range communication and to transmit to the cellular base station a signal corresponding to audio derived from the client handset during the incoming call.

In contrast to the two-part prior art mobile telephone devices such as those described in GB2336966, WO9750269, WO2004025939, WO0056051, GB2353433, DE10347158, WO2004110038, CN201365288, WO2008107536, U.S. Pat. No. 7,031,692, WO2009055976 and GB2364846 in which an entirely new mobile telephone device would have to be designed, manufactured and sold in order to allow the user to reduce harmful cellular radiation, the method and system of the present invention may reduce harmful cellular radiation for users of existing mobile telephones without requiring the user to give up their preferred telephone and buy a new cellular telephone to replace it. Many mobile telephone users have unique features on their phone that reflects their preferences and users may hesitate to buy a mobile telephone that excels in reducing harmful radiation but which may not have the preferred features they adore. Accordingly, in contrast to the prior art, which only protects cellular telephone users if those users take the trouble to purchase a different cellular telelphone from the one they have and may strongly prefer, the method and system of the present invention may protect the millions of exisitng cellular telelphone users from harmful radiation without making these users give up their preferrred mobile telephone. Furthermore, the present system and method may achieve this wihout requiring the company selling such a system to compete against mobile telephone companies for a share of the market of mobile telephones, thereby making it more realistic for a company to offer this system to millions of mobile phone users. In further contrast to the two-part prior art mobile devices, in which if one part of the two-part system is misplaced or lost, the system is useless and no mobile phone capability would remain, the present invention may utilize a stand-alone mobile telephone client. Furthermore, in some embodiments of the server device, the server is a stand-alone mobile telephone also. Accordingly, mobile phone capabiluty would continue to exist for emergency or other temporary use if the client, and in some embodiments if either the client or the server, were somehow misplaced or lost, albeit without radiation reduction (but this would be temporary until the other device was located). In further contrast to prior art physical shields that are designed to try to shield users from harmful cellular radiation without changing the user's phone system, but which by current consensus is not effective or may reduce the quality of service, the system and method of the present invention may be effective and may in fact reduce harmful radiation by cellular users by one order of magnitude or more. The system and method of the present invention may do so without reducing quality of service. In still further contrast to prior art headsets that have the disadvantage of in effect forcing the user to operate two devices, the (i) head set which must be either constantly worn or retireved from where it is stored (i.e. from your pocket) each time a call comes in and (ii) the mobile telephone itself, and which may also impose a danger from the extreme proximity to the brain of the earpiece, the system of the present invention may only require operation of a single device by the user when processing a telephone call. Furthermore, the system and method of the present invention does not require placement of a radiation emitting device inside the ear. Furthermore, unlike a mobile telephone used in conjunction with a headset or physical shields, the client mobile telephone of the present invention may be able to function without the need for recharging for significantly longer periods of time due to the fact that it is not utilizing the power generated by long range communication during calls. At the same time, the server may be plugged into an outlet. In further contrast to prior art femtocells, in which a cellular base station is placed in the home but is not portable to other locations, involves the uncomfortable prospect of putting a cell phone base station in one's home and wherein the user , the present system and method allows positioning of the server wherever the user expects to use the client and does not involve putting a base station in the home. In further contrast to commercial available prior art acoustic exchange tubes that may operate together with head sets, which may reduce radiation only if the tube is long enough, and where the tube may break, or where the product may be unappealing to look at, the present system and method does not attempt to reduce radiation to unnecessarily low levels at the expense of a product that may break and at the expense of appearances that may discourage use by the masses of cellular telephone users. Finally, in contrast to the prior art, which may involve using an existing mobile telephone on speaker mode and distancing oneself from the phone in order to avoid or reduce radiation, and wherein privacy is reduced and the call is less audible, the system and method of the present invention does not compromise privacy or quality.

The principles and operation of a system for a cellular telephone system and method that reduces harmful radiation may be better understood with reference to the drawings and the accompanying description.

The terms “incoming call” and “outgoing call” shall be understood to not include SMS communications. The term “client handset” is broad enough to refer to any microphone or other audio sensor that senses audio derived from the user's voice or sounds external to the client.

Cellular telephones generate power between 1 and 3 watts for long distance communication between the cellular telephone and a cellular base station. The electric power levels are proportional to the electromagnetic radiation emitted from the cellular phone.

The term “short range” communication is understood to include near field communication (NFC) which is up to approximately 0.2 m, Bluetooth class 1 (up to approximately 100 m and generates 100 milliwatt), Bluetooth class 2 (up to approximately 10 m and generates 2.5 milliwatt), Bluetooth class 3 (up to five meters and generates one milliwatt) Wi-Fi communication (approximately 32 m to an access point indoors and approximately 95 m outdoors for IEEE 802.1b router with a stock antenna and generates 100 milliwatt) and other communication systems for communications between devices that are apart from one another at short range distances. Extra sensitive antennas of the server may extend these ranges. Short range communication is defined to be wireless communication and to be such communication that generates approximately 100 milliwatt or less in the client 20. Accordingly, short range communication may generate less power and radiation in client 20 than cellular telephones by an order of magnitude or more, assuming the client's distance from the cellular base station exceeds the distance from the client to the server.

In some preferred embodiments, system 10 utilizes only very short range communication, for example NFC and Bluetooth class 1 and 2.

The term “existing brand” of a mobile telephone means any commercially available mobile telephone having an integrated short range transceiver prior to being retrofitted to work with the system of the pre4sent invention.

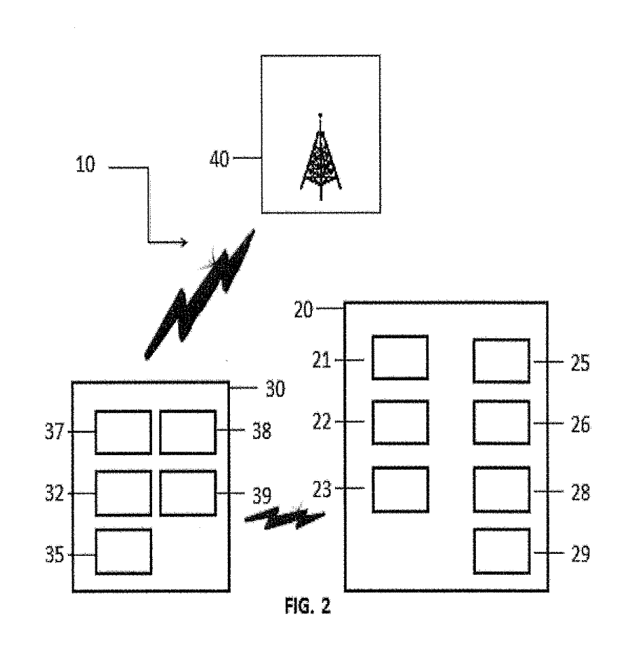

As shown in FIG. 2, a system 10 for mobile telephones that reduces harmful radiation may comprise a client 20 and a server 30. The client 20 may comprise a stand-alone mobile telephone 20 that may have several elements that may be considered standard. For example, client 20 may include a long range transceiver 22 for communication with the cellular base station 40, a handset 26 which may also be called a user interface 26 such as a touch screen or a key pad. Client 20 may also have a short range transceiver 28. This is common in many mobile telephones. Client 20 may also have a processor 21 and a battery 29 and may have a controller 23 and an audio system. 26

ent may be a stand-alone mobile telephone of an existing brand that has been configured with an application for communicating with the server 30. The term “application” as used herein is broad enough to include any kind of software or computer program including application software, system software, middleware, although typically the application for communicating with the server may be application software. Client 20 may have an application or software for short range communication with the server as well as a processor 27. The application may be downloaded or otherwise provided to the client 20. In one preferred embodiment, at the time that the user purchases the system 10, which means purchases the server 30, the user also downloads or otherwise acquires the application or software that allows short range communication between client 20 and server 30. The nature of the short range communication may be that client 20 may be configured to (i) send audio derived from the client handset to the server, (ii) receive audio from the server and play the audio received from the server on a speaker and (iii) send commands to and receive commands from the server. Accordingly, even if client 20 may be a stand-alone mobile telephone of an existing brand that has been configured with an application for communicating with the server 30, it would still need the additional specialized application that allows it to be configured to have short range communications in the manner described.

The following are purely illustrative and non-limiting examples of commands sent to server 30 by client 20 and commands sent to client from server 30: dialing commands from an integrated dialer, dialing commands from a different dialer, commands to answer a call, end a call, notification for incoming calls, etc. and any other commands necessary to effectuate the system 10 or methods (100, 200) of the present invention.

ent 20 also may have a first subscriber identification module 25, which may be a common SIM card 25, which is a removable subscriber identification module in the shape of a card. Regarding both the “second SIM” version and the “remote SIM” version, it should be understood that throughout this patent application the present invention defines subscriber identification module 25 broadly and contemplates other subscriber identification modules known in the art and those not yet developed. For example, typically subscriber identification modules also have encryption features and this may be included in module 25 yet this is not an absolute required element of subscriber identification module 25. Moreover, the subscriber identification module 25 is typically in the form of a card but may take other forms also. For example, the module 25 need not be shaped like a card. Typically, the second subsciber identification module would be of the same type as the first subscriber identifcation module. In addition, typically, the subscriber identification module is a removable module since it is used as a way of indicating that the individual subscriber using one mobile telephone is the same subscriber who uses another mobile telephone. However, the present invention, in some preferred embodiments, also encompasses a subscriber identification method 25 that does not utilize a removable module. For example, in some preferred embodiments the subscriber's identification may be inputted by a keypad or other mechanism into the server 30. In addition, the term “subscriber identification module” should be understood as also encompassing subscriber identification modules that are integrated into the mobile telephone and are not removable as a separate entity.

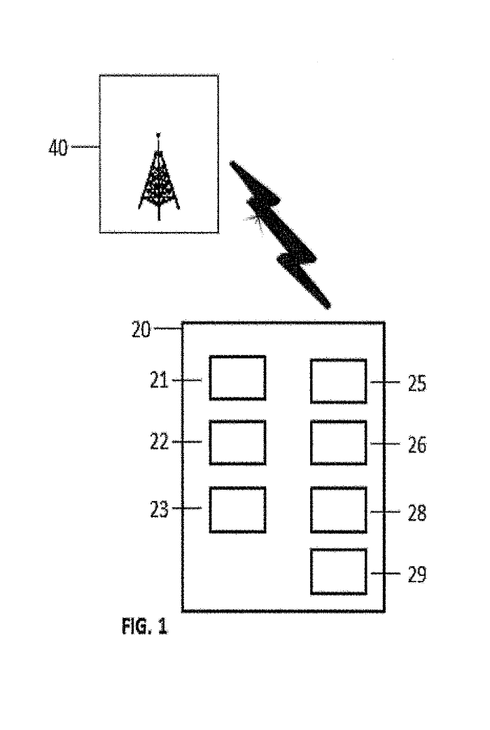

First subscriber identification module 25 may be associated with a particular telephone number, for example a telephone number of a particular subscriber to the cellular network. In some preferred embodiments the term “telephone number” is broad enough to encompass IP addresses and/or other authentication numbers that a carrier chooses to have uniquesly associated with a particular subscriber account.Initially, as shown in FIG. 1, the client 20 and server 30 may be outside communication range with one another, for example if the server has been positioned by the user in the user's office (for example near a window) for situations in which the client mobile telephone will be brought to the office and the user is carrying the client and has not gotten to the office yet. During the time that client 20 and server 30 are not in short range communication with each other, server 30 may be configured to be disconnected from the cellular network while client 20 may be connected to the cellular network and may be used like an ordinary mobile telephone. Once the client and server are in short range communication range they may communicate with each other, As discussed below, the client 20 may not receive incoming calls directly from the cellular base station, yet client 20 may still be on the network in order to receive SMS communications and to use the cellular carrier's data connection.

There could also be some preferred embodiments in which the server 30 is a stand-alone mobile telephone and hence in that case even when client 20 and server 30 are not in communication server 30 can be configured to be enabled for communication with cellular base station 40. However, this is not a necessary requirement for system 10.

As seen from FIG. 2, server 30 may comprise at least a processor 37, a long range cellular transceiver 32 for communication with the cellular base station 40 when the client and server are in communication range and a short range transceiver 38 for communication with the client 20. Server 30 may have a battery 39. In addition, server 30 may have a second subscriber identification module 35 associated with the same telephone number as the telephone number associated with the first subscriber identification module. In some preferred embodiments, as in FIG. 2, server 30 may also contain a user interface (not shown) and may have everything that a stand-alone mobile telephone has (like client 20). However, server 30 may be programmed to not be able to receive SMS messages.

When client 20 and server 30 are in communication range, then when an incoming call is received to system 10 from the cellular base station 40 or when the client 20 initiates an outgoing call (discussed below), client 20 may be configured so as to not be enabled to receive incoming calls from the cellular base station 40 (which is understood to mean other than by way of server 30).

The server 30 may be configured in relation to the cellular network to which cellular base station 40 is connected that server 30, since it has the second subscriber identification module, may have call routing parallel to client 20 or with priority over client 20, which may have the first subscriber identification module 25. This means that when sever 30 and client 20 are in short range communication and a call comes in it is always routed to server 30 . Similarly, when an outgoing call is made, that is when client 20 may dial a number to make a call, that number may be sent to server 30 and server 30 may use its long range communication transceiver to make the outgoing call.

Accordingly, server 30 may be configured, when in communication range with the client, to receive an incoming call from the cellular base station 40 and to transfer audio from that incoming call to client 20 using short range communications. Furthermore, server 30 may be configured to receive audio from the client handset 26 by short range communication and to transmit a signal corresponding to audio derived from the client handset 26 to cellular base station 40 during the incoming call. In this way, the user holding the handset 26 of client 20 may only experience the radiation normally associated with short range communication between client and server rather than the more harmful radiation from long range communication from server 30 to base station 40. In addition, server 30 may be configured to send commands to and receive commands from client 20.

With respect to outgoing calls, server 30 may be configured, when in communication range with the client, and upon receipt from the client of a phone number for an outgoing call, to transmit that phone number to the cellular base station to actuate the outgoing call, and once said outgoing call is connected, to transfer audio from the outgoing call to the client by short range communication, to receive audio derived from the client handset by short range communication and to transmit to the cellular base station a signal corresponding to audio from the client handset during the outgoing call.

It is noted that references to incoming calls and outgoing calls are not intended to include SMS communications, which are not considered “calls” in this regard. With regard to SMS communications, client 20 may be configured, for example by the application, that during an incoming call and during an outgoing call, the client is connected to the cellular network and enabled to receive at least one of (i) SMS communications, (ii) data and (iii) SMS communications and data. In this version of the “second SIM” version, there would be cellular radiation during the very short interval of the SMS communication and cellular stand-by mode since the user places his or her head near the client during the call.

Alternatively, client 20 may be configured, for example by the application, that during the incoming or outgoing call, client 20 is disconnected from the cellular network and not enabled to receive SMS communications. In that case, SMS messages would accumulate, if any, and the carrier would provide them when the client 20 is again re-enabled and connected to the network, i.e. when the call is terminated.

The application may enable the user to select which option, and hence which configuration for SMS to use.

The application may include a configuration for whether the client 20 is enabled for. SMS communications during incoming and outgoing calls, or may include a setting for the client 20 to be enabled for SMS during incoming calls alone or during outgoing calls alone.

Accordingly, client 20 and server 30 may be configured so that when client 20 and server 30 are in communication range during a period when there is no incoming call and no outgoing call, client 20 and server 30 are each enabled for communication with the cellular base station 40. However, client 20 may be connected to base station so to be enabled to receive SMS communications and server 30 may be enabled to receive incoming calls but is programmed to not be able to receive SMS communications. The call routing and the SMS routing may be configured in the cellular carrier system.

In some other preferred embodiments of the second SIM version, however, server 30 may be programmed to received SMS communication and transfer them to the client 20 using short range communications and to receive SMS communication with a designated destination number from the client 20 through short range communication and transmit them to the cellular base station 40. Client 20 may be configured by the application to receive SMS communication from server 30 and to transfer SMS communication with a designated destination phone number to server 30 through short range communication.

Accordingly, in this version, SMS communication may be received and transmitted during calls by client 20 without the cellular radiation associated with long range communication as client 20 may be disconnected from the cellular network. In this version, client 20 may be configured by the application to be disconnected from the cellular network whenever client 20 and server 30 are in communication. Alternatively, client 20 may be configured by the application to be disconnected from the cellular network whenever both of the following conditions occur: (i) client 20 and server 30 are in communication and (ii) incoming calls or outgoing calls are occurring.

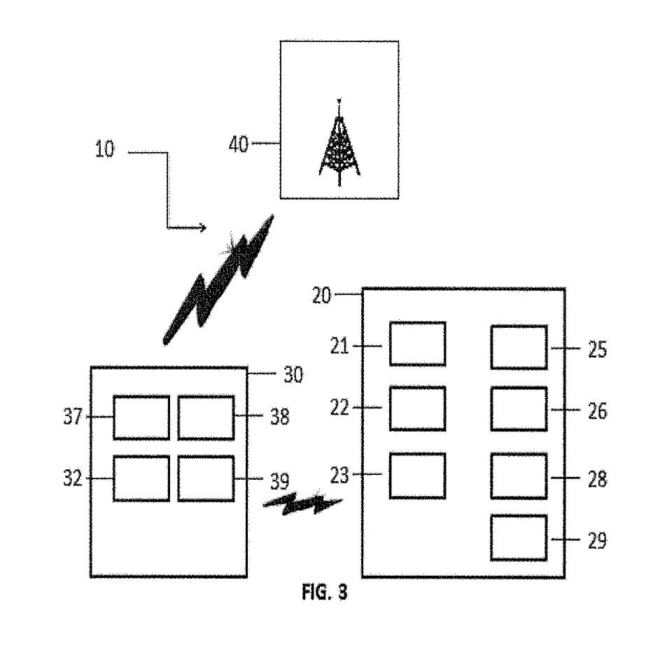

As noted, the above system 10 of FIGS. 1-2 may be described as the “second SIM” version. The following version may be viewed from FIG. 1 and FIG. 3.

As shown in FIG. 3, the following system 10 may be called the “remote SIM” version. Essentially, the difference is that in the remote SIM version, instead of server 30 having a physical second subscriber identification module, server 30 has no physical subscriber identification module but the subscriber identification module data is sent by short range communication from the client to the server when they are in short range communication. Client 20 may have a subscriber identification module 25 (which may be the same as the “first” subscriber identification module 25 of the client 20 in the second SIM version). Since server 30 has no physical subscriber identification module, when server 30 is out of communication range of client 20, server 30 may be unlisted or un-recognized by the cellular network to which cellular base station 40 is connected, at least not a cellular network that requires subscriber identification modules. In terms of retrofitting an existing system, the “remote SIM” version has the business advantage over the “second SIM” version that in the “remote SIM” version one does not need to approach the cellular carrier that issued the first subscriber identification module to have it issue a second subscriber identification module.

In this version, as seen in FIG. 3, when the client 20 is out of communication range of the server 30, client 20 may be on the cellular network and may operate like any stand-alone mobile telephone. In addition, once communication has been established between client 20 and server 30, in this remote SIM version, client 20 may be configured to transfer subscriber identification module data of the subscriber identification module to server 30. Once server 30 has received subscriber identification module, server 30 may be enabled for communication with the cellular network of the cellular base station (i.e. to be on the cellular network) and client 20 may be disabled for communication with the cellular network of the cellular base station (i.e. to be off the cellular network).

Server 30, not having a subscriber identification module, may be configured to be disconnected from the cellular network when server 30 is not in communication with client 20. Server 30 may be configured to send commands to and receive commands from client 20.

Client 20 may be configured so that it is enabled, using short range communication, to (i) send audio derived from a client handset to the server, (ii) receive audio from the server and play the audio received from the server on a speaker and (iii) send commands to and receive commands from the server 30.

Server 30 may be configured to transfer audio from the incoming call to the client by short range communication, to receive audio from the client handset by short range communication and to transmit to the cellular base station a signal corresponding to audio derived from the client handset during the incoming call.

Regarding outgoing calls, server 30 may be configured, when in communication range with the client, and upon receipt from the client of a phone number for an outgoing call, to transmit the phone number to the cellular base station to actuate the outgoing call, and once said outgoing call is connected, to transfer audio from the outgoing call to the client by short range communication, to receive audio derived from the client handset by short range communication and to transmit to the cellular base station a signal corresponding to audio from the client handset during the outgoing call.

Server 30 may be programmed to receive SMS communications and transfer them to the client 20 using short range communications and to receive SMS with a designated (destimation) phone number from the client 20 through short range communication and transmit them to the cellular base station 40. Client 20 may be configured by the application to receive SMS from server 30 and to transfer SMS with a designated (destination) phone number to server 30 through short range communication.

Accordingly, in this version, SMS messages may be received and transmitted during calls by client 20 without the cellular radiation associated with long range communication since client 20 may be disconnected from the cellular network.

As before, client 20 may be a stand-alone mobile telephone of an existing brand that has been configured with an application for communicating with the server,

In both the second SIM version and the remote SIM versions server 30 may be positioned at a distance from the user so as to eliminate or minimize harmful cellular radiation derived from server 30 during incoming and outgoing calls as server uses its transceiver for long range communication with base station 40. Accordingly, any radiation that server 30 emits should not affect the user. Server 30 may be kept in a particular place whereas client 20 may be carried by the user, although this is not always the case. For example, it may be that server 30 is positioned as far away from user, who may be carrying client 20, as possible while still allowing for short range communication between server 30 and client 20 when the user wishes to use client 20. For example, the user may carry client 20 yet place server 30 in his office almost ten meters from where the user is likely to use client 20. Server 30 may be positioned in any suitable place in relation to the client 20. For example, server 30 may be placed adjacent an office window for good reception. The distance between server 30 and client 20 may depend on the nature of the short range communication. For example, for short range communications based on Bluetooth “class one” that distance may be up to a hundred meters. Other distances may be appropriate for other versions of Bluetooth or NFC or Wi-Fi or other short range communication systems. Furthermore, “short range communication” takes into consideration the possibility that server 30 may have an especially sensitive antenna for short range communications thus allowing server 30 to be positioned significantly farther away from client 20 than the standard distances given for Bluetooth or other short range communication protocols.

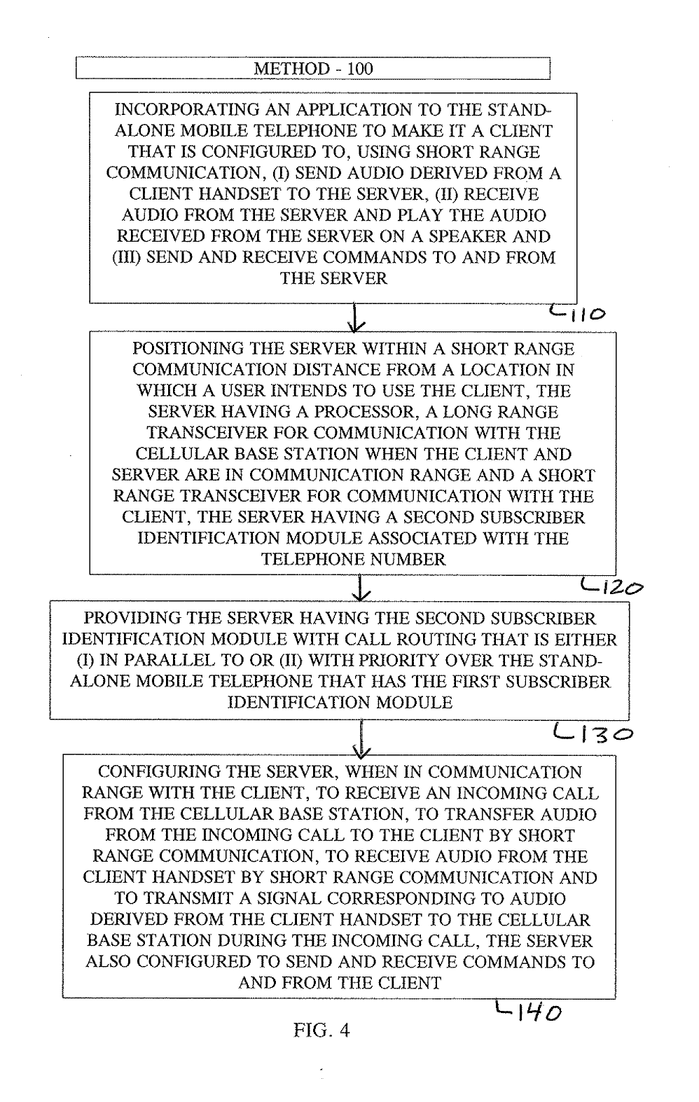

As seen from FIG. 4, the present invention may also be characterized as a method 100 of retrofitting a mobile telephone to reduce harmful radiation where the mobile telephone may be a stand-alone mobile telephone or client 20 that may have a long range transceiver for communication with a cellular base station, a handset, a user interface (such as touch screen/key pad), a first subscriber identification module that may be associated with a telephone number and a short range transceiver. Method 100 may utilize or correspond to the second SIM version of system 10. Method 100 may include a step 110 of incorporating an application to the stand-alone mobile telephone (which may be an existing brand mobile telephone), the application To configured to make it a client that is configured to, using short range communication, (i) send audio derived from a client handset to the server 30, (ii) receive audio from the server and play the audio received from the server on a speaker and (iii) send and receive commands to and from the server. A further step 120 may involve positioning the server 30 within a short range communication distance from a location in which a user intends to use the client 20, the server 30 having a processor, a long range transceiver for communication with the cellular base station when the client and server are in communication and a short range transceiver for communication with the client, the server having a second subscriber identification module 35 associated with the same telephone number.

Method 100 may also include a step 130 of having a cellular network to which the cellular base station 40 is connected provide the server 30 that has the second subscriber identification module 35 with call routing that is either in parallel to or with priority over, the stand-alone mobile telephone 20 that has the first subscriber identification module 25 There could be other embodiments in which providing the server 30 that has the second subscriber identification module 35 with call routing priority over the client 20 having the first subscriber identification module 25 occurs through settings by the user without contacting the carrier, although this is not the norm today. For example, there could be a way to program it into the client or server directly.

A further step 140 may involve configuring the server, when in communication range with the client, to receive an incoming call from the cellular base station, to transfer audio from the incoming call to the client by short range communication, to receive audio from the client handset by short range communication and to transmit a signal corresponding to audio derived from the client handset to the cellular base station during the incoming call. The server 30 and client 20 may also be configured to send commands to and receive commands from each other.

Method 100, in some versions, may have a step of configuring the client so as to not be enabled to receive incoming calls directly from the cellular base station when the client is in short range communication with the server.

In some versions of method 100, the server may also be configured, when the client is not in communication with the server, to be disconnected from the cellular network. In some versions of method 100, the method 100 may also include a step of the application including an option to have the client configured that during an incoming call and during an outgoing call, the client is connected to the cellular network and enabled to receive at least one of (i) SMS communications, (ii) data and (iii) SMS communications and data. In some versions, the method may include a step of having the application include an option to have the client configured that when an incoming call is received (or during incoming and outgoing calls), the client is disconnected from the cellular network.

In some versions of method 100 there may be a further step of configuring the server 30 that when the server 30 is in communication range with the client 20, upon receipt from the client 20 of a phone number for an outgoing call, the server 30 transmits that phone number to the cellular base station 40 to actuate that outgoing call, and once the outgoing call is connected, the server transfers audio from the outgoing call to the client by short range communication, to receive audio derived from the client handset by short range communication and to transmit to the cellular base station 40 a signal corresponding to audio from the client handset during the outgoing call. There may also be, in some versions, a step of method 100 involving incorporating the application with a configuration for whether the client is enabled for SMS communications during at least one of incoming calls and outgoing calls.

In some versions of method 100, there may be a step of configuring the server to be enabled to receive SMS from the cellular base station and transfer them to the client through short range communication and receive SMS with a designated phone number from the client and transmit them to the base station. The step may include configuring the client to receive SMS from the server and to transfer SMS with a designated phone number to the server through short range communication. The step may also include configuring the client so that when the client and server are in communication the client is always disconnected from the cellular network.

Method 100 may involve configuring the stand-alone mobile telephone of an existing brand with an application for communicating with the server.

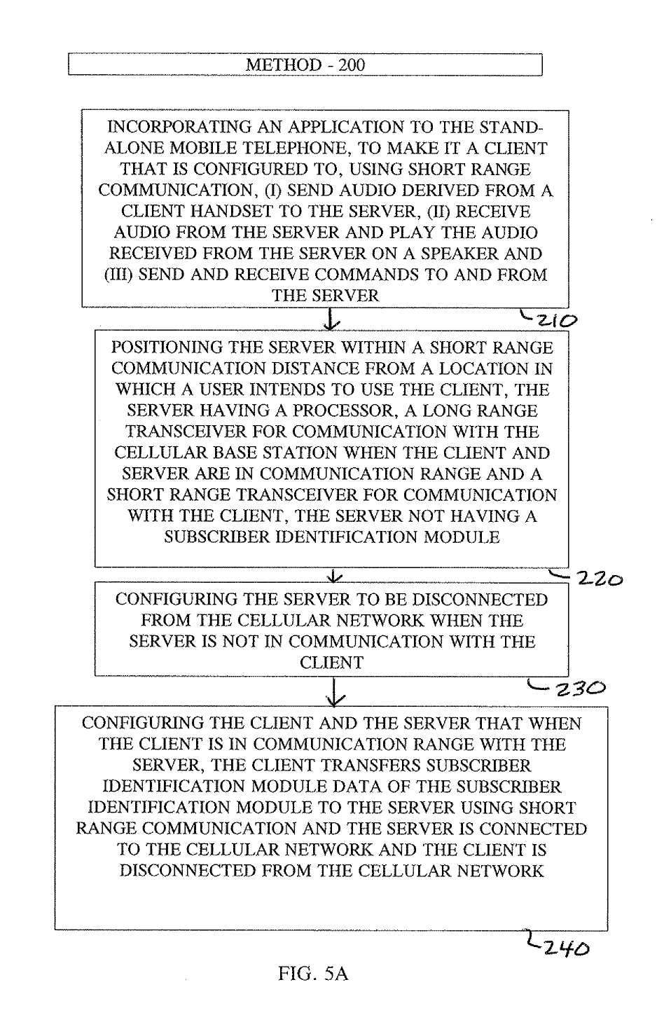

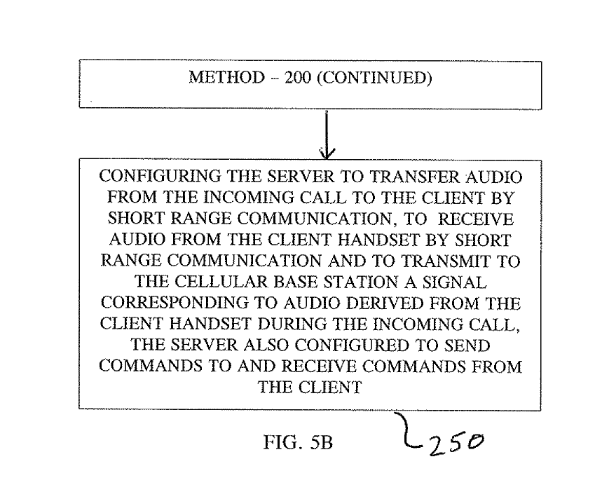

As seen in FIGS. 5A-513, in a further method 200 of the present invention, which may utilize or correspond to the remote SIM version of system 10, the present invention may be described as a method 200 of retrofitting a mobile telephone to reduce harmful radiation, where the mobile telephone may be a stand-alone mobile telephone that may have a long range transceiver for communication with a cellular base station, a handset, a user interface (such as touch screen/key pad), a subscriber identification module and a short range transceiver. As seen in FIG. 5A, method 200 may comprise a first step 210 of incorporating an application to the stand-alone mobile telephone to make it a client that is configured to, using short range communication, (i) send audio derived from a client handset to the server, (ii) receive audio from the server and play the audio received from the server on a speaker and (iii) send and receive commands to and from the server.

Method 200 may also include a step 220 of positioning the server within a short range communication distance from a location in which a user intends to use the client, the server having a processor, a long range transceiver for communication with the cellular base station when the client and server are in communication range and a short range transceiver for communication with the client, the server not having a subscriber identification module.

Method 200 may also involve a step 230 of configuring the server to be disconnected from the cellular network when the server is not in communication with the client. Method 200 may include an additional step 240 of further configuring the client, that when the client is in communication range with the server the client transfers subscriber identification module data of the subscriber identification module to the server using short range communication and the server may be connected to the cellular network and the client may be disconnected from the cellular network. As seen in FIG. 5B, an additional step 250 may involve configuring the server to transfer audio from the incoming call to the client by short range communication, to receive audio from the client handset by short range communication and to transmit to the cellular base station a signal corresponding to audio derived from the client handset during the incoming call. Step 250 may also include the server also being configured to send commands to and receive commands from the client.

In some versions of method 200, client 20 may be configured to be enabled for communication with a cellular network of the cellular base station when the client is not in short range communication with the server

In some versions of method 200 server 30 may be programed to be enabled to receive from and transmit to the cellular base station 40 SMS communication, and also to be enabled to receive from and transfer to client 20 SMS communication through short range communication. Client 20 may be enabled, utilizing short range communication, to send to and receive from server 30 SMS communications.

In some versions of method 200, there is also a step of configuring the server that when the server is in communication range with the client upon receipt from the client of a phone number for an outgoing call , the server transmits the phone number to the cellular base station to actuate the outgoing call, and once said outgoing call is connected, to transfer audio from the outgoing call to the client by short range communication, receives audio derived from the client handset by short range communication and to transmit to the cellular base station a signal corresponding to audio from the client handset during the outgoing call.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A system for mobile telephones that reduces harmful radiation, comprising:
a server;
a client comprising a stand-alone mobile telephone including a long range transceiver for communication with a cellular base station, a handset and a user interface and including a short range transceiver and an application for short range communication with the server, the client having a first subscriber identification module associated with a telephone number and configured to, using short range communication, (i) send audio derived from a client handset to the server, (ii) receive audio from the server and play the audio received form the server on a speaker and (iii) send commands to and receive commands from the server;
the server comprising a processor, a long range transceiver for communication with the cellular base station when the client and server are in communication range and a short range transceiver for communication with the client, the server having a second subscriber identification module, the second subscriber identification module being associated with the telephone number,
the server configured in relation to a cellular network to which the cellular base station is connected that the server having the second subscriber identification module has one of (i) call routing in parallel to the client that has the first subscriber identification module, and (ii) call routing priority over the client,
the server configured, when in communication range with the client, to receive an incoming call from the cellular base station, to transfer audio from the incoming call to the client by short range communication, to receive audio from a client handset by short range communication and to transmit a signal corresponding to audio derived from the client handset to the cellular base station during the incoming call, the server also configured to send and receive commands to and from the client.

2. The system of claim 1, further comprising the server also configured, when the client is not in communication with the server, to be disconnected from the cellular network.

3. The system of claim 1, further comprising the client further configured by the application that during an incoming call and during an outgoing call the client is connected to the cellular network and enabled to receive at least one of (i) SMS communications, (ii) data and (iii) SMS communications and data.

4. The system of claim 1, further comprising the client configured by the application that during an incoming call and during an outgoing call, the client is disconnected from the cellular network.

5. The system of claim 1, further comprising the client configured by the application that whenever the client and server are in communication the client is disconnected from the cellular network

6. The system of claim 5, further comprising the server configured to receive SMS from the cellular base station and transfer them to the client through short range communication and to receive SMS with a designated phone number from the client through short range communication and to transmit them to the cellular base station.

7. The system of claim 5, further comprising the client configured by the application to receive SMS from the server and to transfer SMS with a designated phone number to the server through short range communication.

8. The system of claim 1, wherein the server is also a stand-alone mobile telephone that includes a user interface.

9. The system of claim 1, further comprising the client and server configured so that when the server and client are in communication range during a period when there is no incoming call and no outgoing call, the client and server are each enabled for communication with the cellular base station.

10. The system of claim 9, further comprising the client is enabled to send and receive SMS communications but not incoming calls and the server is enabled to receive incoming calls but is programmed to not be able to receive SMS communications.

11. The system of claim 1, further comprising the server configured, when in communication range with the client, and upon receipt from the client of a phone number for an outgoing call, to transmit that phone number to the cellular base station to actuate the outgoing call, and once said outgoing call is connected, to transfer audio from the outgoing call to the client by short range communication, to receive audio derived from the client handset by short range communication and to transmit to the cellular base station a signal corresponding to audio from the client handset during the outgoing call.

12. The system of claim 1, wherein the client is a stand-alone mobile telephone of an existing brand that has been configured with an application for communicating with the server, the application including a configuration for whether the client is enabled for SMS communications during at least one of incoming calls and outgoing calls.

13. The system of claim 1, wherein the client is a stand-alone mobile telephone of an existing brand that has been configured with an application for communicating with the server.

14. A system for mobile telephones that reduces harmful radiation, comprising:
a server;
a client comprising a stand-alone mobile telephone including a long range transceiver for communication with a cellular base station, a handset and user interface and including a short range transceiver and an application for short range communication with a server,
the client having a subscriber identification module and configured, when the client is not in short range communication with the server , to be enabled for communication with a cellular network of the cellular base station, the client also configured to, using short range communication, (i) send audio derived from a client handset to the server, (ii) receive audio from the server and play the audio received from the server on a speaker and (iii) send commands to and receive commands from the server;
the server comprising a processor, a long range transceiver for communication with the cellular base station when the client and server are in communication range and a short range transceiver for communication with the client, the server not having a subscriber identification module and configured to be disconnected from the cellular network when the server is not in communication with the client;
the client and the server configured such that when the client is in communication range with the server, the client transfers subscriber identification module data of the subscriber identification module to the server thereby enabling the server to be recognized for communication by the cellular base station and the client to be disconnected from the cellular network, cellular communication being routed to the server,
the server configured to transfer audio from the incoming call to the client by short range communication, to receive audio from the client handset by short range communication and to transmit to the cellular base station a signal corresponding to audio derived from the client handset during the incoming call, the server also configured to send commands to and receive commands from the client.

15. The system of claim 14, wherein the server is also a stand-alone mobile telephone that includes a user interface.

16. The system of claim 14, wherein the client is a stand-alone mobile telephone of an existing brand that has been configured with an application for communicating with the server.

17. The system of claim 14, further comprising the server configured, when in communication range with the client, and upon receipt from the client of a phone number for an outgoing call , to transmit the phone number to the cellular base station to actuate the outgoing call, and once said outgoing call is connected, to transfer audio from the outgoing call to the client by short range communication, to receive audio derived from the client handset by short range communication and to transmit to the cellular base station a signal corresponding to audio from the client handset during the outgoing call. the server also configured to send commands to and receive commands from the client.

18. The system of claim 14, further comprising the server configured to receive SMS communication from the cellular base station and transfer SMS communication to the client through short range communication and to receive SMS communication together with a designated destination phone number from the client through short range communication and to transmit the SMS communication to the cellular base station.

19. The system of claim 14, further comprising the client configured by the application to receive SMS communication from the server and to transfer SMS communication with a designated destination phone number to the server through short range communication.

20. A method of retrofitting a mobile telephone to reduce harmful radiation, the mobile telephone being a stand-alone mobile telephone having a long range transceiver for communication with a cellular base station, a handset, a user interface, a first subscriber identification module associated with a telephone number and a short range transceiver, the method comprising:
incorporating an application to the stand-alone mobile telephone to make it a client that is configured to, using short range communication, (i) send audio derived from a client handset to the server, (ii) receive audio from the server and play the audio received from the server on a speaker and (iii) send and receive commands to and from the server;
positioning the server within a short range communication distance from a location in which a user intends to use the client, the server having a processor, a long range transceiver for communication with the cellular base station when the client and server are in communication range and a short range transceiver for communication with the client, the server having a second subscriber identification module associated with the telephone number;
providing the server having the second subscriber identification module with call routing that is either (i) in parallel to or (ii) with priority over, the stand-alone mobile telephone that has the first subscriber identification module; and
configuring the server, when in communication range with the client, to receive an incoming call from the cellular base station, to transfer audio from the incoming call to the client by short range communication, to receive audio from the client handset by short range communication and to transmit a signal corresponding to audio derived from the client handset to the cellular base station during the incoming call, the server also configured to send and receive commands to and from the client.

21. The method of claim 20, further comprising the server also configured when the client is not in communication with the server, to be disconnected from the cellular network.

22. The method of claim 20, further comprising the application including an option to have the client configured that during an incoming call and during an outgoing call, the client is connected to the cellular network and enabled to receive at least one of (i) SMS communications, (ii) data and (iii) SMS communications and data.

23. The method of claim 20, further comprising the application including an option to have the client configured that when an incoming call is received, the client is disconnected from the cellular network.

24. The method of claim 20, further comprising configuring the server that when the server is in communication range with the client, upon receipt from the client of a phone number for an outgoing call, the server transmits that phone number to the cellular base station to actuate that outgoing call, and once said outgoing call is connected, to transfer audio from the outgoing call to the client by short range communication, to receive audio derived from the client handset by short range communication and to transmit to the cellular base station a signal corresponding to audio from the client handset during the outgoing call.

25. The method of claim 20, further comprising incorporating the application with a configuration for whether the client is enabled for SMS communications during at least one of incoming calls and outgoing calls.

26. The method of claim 20, further comprising configuring the client so that when the client and server are in communication range the client is disconnected from the cellular network.

27. The method of claim 26, further comprising the server configured to receive SMS communication from the cellular base station and transfer SMS communication to the client through short range communication and to receive SMS communication with a designated destination phone number from the client through short range communication and to transmit SMS sommunication to the cellular base station.

28. The method of claim 27, further comprising the client configured by the application to receive SMS communication from the server and to transfer SMS communication with a designated destination phone number to the server through short range communication.

29. The method of claim 20, further comprising configuring the stand-alone mobile telephone of an existing brand with an application for communicating with the server

30. A method of retrofitting a mobile telephone to reduce harmful radiation, the mobile telephone being a stand-alone mobile telephone having a long range transceiver for communication with a cellular base station, a handset, a user interface, a subscriber identification module and a short range transceiver, the method comprising:
incorporating an application to the stand-alone mobile telephone, to make it a client that is configured to, using short range communication, (i) send audio derived from a client handset to the server, (ii) receive audio from the server and play the audio received from the server on a speaker and (iii) send and receive commands to and from the server;
positioning the server within a short range communication distance from a location in which a user intends to use the client, the server having a processor, a long range transceiver for communication with the cellular base station when the client and server are in communication range and a short range transceiver for communication with the client, the server not having a subscriber identification module;
configuring the server to be disconnected from the cellular network when the server is not in communication with the client;
configuring the client and the server such that when the client is in communication range with the server, the client transfers subscriber identification module data of the subscriber identification module to the server using short range communication, the server is connected to the cellular network and the client is disconnected from the cellular network; and
configuring the server to transfer audio from the incoming call to the client by short range communication, to receive audio from the client handset by short range communication and to transmit to the cellular base station a signal corresponding to audio derived from the client handset during the incoming call, the server also configured to send commands to and receive commands from the client.

31. The method of claim 30, further comprising configuring the client to be enabled for communication with a cellular network of the cellular base station when the client is not in short range communication with the server.

32. The method of claim 30, wherein the server is a stand alone mobile telephone that includes a user interface.

33. The method of claim 30, wherein the client is a stand-alone mobile telephone of an existing brand that has been configured with an application for communicating with the server.

34. The method of claim 30, further comprising the server configured to receive SMS communication from the cellular base station and transfer the SMS communication to the client through short range communication and to receive outgoing SMS communication with a designated destination phone number from the client through short range communication and to transmit the outgoing SMS communication to the cellular base station.

35. The method of claim 30, further comprising the client configured by the application to receive SMS communication from the server and to transfer SMS communication with a designated destination phone number to the server through short range communication.

36. The method of claim 30, further comprising configuring the server that when the server is in communication range with the client, upon receipt from the client of a phone number for an outgoing call the server transmits the phone number to the cellular base station to actuate the outgoing call, and once said outgoing call is connected, the server transfers audio from the outgoing call to the client by short range communication, receives audio derived from the client handset by short range communication and transmits to the cellular base station a signal corresponding to audio from the client handset during the outgoing call.
